(19) United States
(12) Patent Application Publication
(10) Pub. No.: US 2025/0257802 A1
(43) Pub. Date: Aug. 14, 2025

(54) AUTOMATED BULK TANK PRESSURE EXHAUST VALVE WITH QUICK CONNECT COUPLING AND VALVE CLOSED INDICATOR LIGHT

(71) Applicant: Bulk Tank, Inc., Park Hills, MO (US)

(72) Inventors: David E. Sisk, Bonne Terre, MO (US); Peter Kemp, Crestwood, MO (US); Roger Breakfield, Farmington, MO (US); Andrew Boyer, Bonne Terre, MO (US); Travis Kinneman, Fredericktown, MO (US); Todd Watkins, Farmington, MO (US); Paul Lipp, Festus, MO (US); Dylan Whitter, Bonne Terre, MO (US)

(21) Appl. No.: 19/048,566

(22) Filed: Feb. 7, 2025

Related U.S. Application Data
(60) Provisional application No. 63/551,839, filed on Feb. 9, 2024.
(60) Provisional application No. 63/671,492, filed on Jul. 15, 2024.

(51) Int. Cl. F16K 1/30; F16K 31/44

(52) U.S. Cl. CPC F16K 1/30; F16K 31/44

(57) ABSTRACT

An automated bulk tank pressure exhaust valve automatically exhaust air pressure from a bulk tank of a bulk tank trailer in response to a sensor operatively communicating with the exhaust valve sensing an absence of air pressure or air flow in a tank pipe communicating with the bulk tank. The sensor is also operatively communicated with in alarm that is activated in response to the sensor sensing air pressure or air flow in the tank pipe or a truck coupled to the bulk tank trailer.

### CROSS REFERENCE TO RELATED APPLICATIONS

This patent application claims the benefit of the filing date of provisional patent application Ser. No. 63/551,839, filed Feb. 9, 2024, and the benefit of the filing date of provisional patent application Ser. No. 63/671,492, filed Jul. 15, 2024, both of which are incorporated herein by reference.

### BACKGROUND OF THE INVENTION

FIG. 1 is a representation of a side elevation view of a conventional pneumatic dry bulk material trailer 10. Trailers of this type transport dry bulk materials such as powders and granular materials. The trailer 10 is basically comprised of a generally cylindrical tank 12 that functions as a pneumatic pressure vessel. There are several (three shown) access openings on the top of the tank with manual covers 14 secured and sealed over the access openings. The covers 14 can be opened to gain access to the interior of the tank 12 when loading the tank or when cleaning the tank. A plurality of hoppers 16 (three shown) are provided along the bottom surface of the length of the tank 12. A valve, for example a butterfly valve 18 is provided on each of the hoppers 16. The butterfly valves 18 are operable to open and communicate the interior of the tank 12 with T-fittings on the bottoms of the hoppers 16 that connect the hoppers 16 with a discharge pipe 20 when unloading the tank 12.

An air pipe 22 extends along the length of the trailer 10 and along the length of the tank 12. The air pipe 22 has an input end 24 shown to the left in FIG. 1 and FIG. 2. The input end 24 of the air pipe 22 is connected to a source of air pressure on a truck (not shown) that is connected to or coupled to the trailer 10 for towing the trailer. For example, the air pipe 22 is connected to a blower on the truck when the trailer is connected to the truck. The source of air pressure on the truck delivers pressurized air to the air pipe 22. Alternatively, the source of air pressure could be a part of the pneumatic dry bulk trailer 10, for example a reservoir air pressure tank for the air brakes of the trailer or could be a separate source of air pressure on the trailer. The air pipe 22 extends along the length of the trailer 10 and supplies air pressure to aerators positioned at the bottoms of each of the hoppers 16 and also supplies air pressure to the discharge pipe 20. The air pressure delivered to the bottoms of the hoppers 16 mixes with the dry bulk material in the tank 12 and assists in the pneumatic conveyance or flow of the dry bulk material from the interior of the tank 12 and the hoppers 16 through the hopper valves 18 to the discharge pipe 20. The pressurized air supplied to the discharge pipe 20 pneumatically conveys the dry bulk material from the tank 12 through the discharge pipe 20 to an outlet end of the discharge pipe.

As described above, the air pipe 22 also supplies pressurized air to the interior of the tank 12. The pressurized air supplied to the interior of the tank 12 mixes with the dry bulk material contained in the tank and assists in the unloading of the dry bulk material from the tank 12 through the hoppers 16, the valves 18 and the discharge pipe 20.

FIG. 2 is a representation of a forward portion of the trailer 10 shown to the left in FIG. 1. As shown in FIGS. 1 and 2, a tank pipe 28 is connected to the top of the tank 12 and communicates with the interior of the tank. The tank pipe 28 extends from the top of the tank 12 downward to a blow down valve or exhaust valve 30 and then to an exhaust pipe 32. As shown, the exhaust valve 30 is connected between the tank pipe 28 and the exhaust pipe 32. The exhaust pipe 32 communicates with the exterior environment or the surrounding atmosphere of the tank 12. The exhaust valve 30 is a manually operated valve with a manual handle 34 that controls communication between the interior of the tank 12 and the exterior environment or atmosphere of the tank.

When the exhaust valve 30 is manually positioned in a first position represented in FIG. 1 and FIG. 2 with the manual handle 34 of the valve directed downward, the valve is opened and the interior of the tank 12 is connected in communication through the tank pipe 28, the exhaust valve 30 and the exhaust pipe 32 with the exterior environment of the tank. This enables the air pressure in the tank 12 to be exhausted through the tank pipe 28, the exhaust valve 30 and the exhaust pipe 32. This also prevents a build up of air pressure in the tank 12. When the handle 34 of the exhaust valve 30 is moved one quarter turn in a counterclockwise direction to a second position of the valve 30, the valve closes and seals communication between the tank pipe 28 and the exhaust pipe 32 and blocks communication between the interior of the tank 12 and the exterior environment or atmosphere of the tank. With the exhaust valve 30 in the second, closed position, the air pressure supplied through the air pipe 24 to the interior of the tank 12 builds up in the interior of the tank and is not exhausted through the tank pipe 28 and the exhaust pipe 32.

The type of dry bulk trailer 10 represented in FIG. 1 and FIG. 2 is loaded with dry bulk material in a powder or granular form. The tank 12 is loaded by the dry bulk material being deposited into the tank through the opened manual covers 14 on the access openings at the top of the tank 12. Alternatively, the tank 12 could be loaded by pneumatic conveyance of the dry bulk material into the tank. When loading is complete, the manual covers 14 are closed and sealed over the access openings, and any other access openings used in the conveyance of the dry bulk material into the tank are closed and sealed, sealing the interior of the tank 12.

To unload the dry bulk material from the tank 12, the exhaust valve 30 is moved to the second, closed position and pressurized air is supplied through the air pipe 22 to the interior of the tank 12. The pressurized air supplied to the interior of the tank 12 is mixed with the dry bulk material in the tank. The valves 18 on the hopper 16 are opened and the dry bulk material mixed with the pressurized air supplied to the interior of the tank 12 is conveyed or forced from the tank 12 by the pressurized air through the opened valves 18 and exits the tank through the discharge pipe 20. The dry bulk material is conveyed from the interior of the tank 12 along with the flow of pressurized air through the hopper 16 and the valves 18 and through the discharge pipe 20. The dry bulk material conveyed through the discharge pipe is discharged from the discharge pipe at a desired location.

This type of unloading of the tank 12 creates a great deal of air pressure inside the tank. When the unloading of the tank 12 is complete and the valves 18 on the hopper 16 are closed, the air pressure being supplied to the tank builds up inside the tank and must be relieved or exhausted for safety considerations. Even after the supply of air pressure to the tank 12 is stopped, there remains air pressure built up in the tank. If the tank 12 were to be left pressurized after unloading, an individual removing a manual cover 14 or removing a pipe cap of the trailer 10 could become injured by the rapid release of pressurized air from the tank 12.

To remove any potential for injury such as that described above, conventional dry bulk trailers 10 are provided with the manually operated blow down valve or exhaust valve 30 such as that described above and represented in FIGS. 1 and 2. The valve 30 is represented in its first, open position with the valve handle 34 directed downward in FIGS. 1 and 2. In the first, open position the exhaust valve 30 communicates the interior of the tank 12 with the tank pipe 28 and the exhaust pipe 32 and the exterior environment of the tank 12. This enables air pressure in the tank 12 to be exhausted from the tank through the tank pipe 28, the exhaust valve 30 and the exhaust pipe 32 to the exterior environment of the tank. To move the exhaust valve 30 to its second, closed position closing communication between the interior of the tank 12, the tank pipe 28, the exhaust pipe 32 and the exterior environment, the handle 34 is moved one quarter turn in the counterclockwise direction to the second, close position of the valve handle 34 and the second, close position of the valve 30. The second position of the exhaust valve 30 closes or seals communication between the tank pipe 28 and the exhaust pipe 32 and between the interior of the tank 12 and the exterior environment of the tank. The first position of the valve 30 opens communication and vents air pressure from the interior of the tank 12.

When unloading of the tank 12 is complete and the trailer 10 is not in use, the exhaust valve 30 should always be in the first, open position as a safety consideration. Even when the trailer 10 is not in use, if the exhaust valve 30 is closed air pressure can build up inside the tank 12 due to changing atmospheric conditions or the changing temperature of the tank environment. For example, sunlight can heat the tank 12 and create an increase in air pressure in the tank. To prevent the dangerous buildup of air pressure inside the tank 12, the manual exhaust valve 30 should always be moved to its first position when the trailer 10 is not in use.

However, positioning the manual exhaust valve 30 in the first, open position requires that the valve handle 34 be manually moved to the downward extending position. Through operator error or inattentiveness, the position of the handle 34 of the manual exhaust valve 30 can be overlooked and left in the second, closed position unintentionally.

### SUMMARY OF THE INVENTION

The bulk tank pressure relief system of this disclosure employs an automated bulk tank pressure blowdown valve or exhaust valve having a quick connect coupling and valve closed indicator light. The pressure exhaust valve replaces the conventional manual exhaust valve and eliminates the potential for injury associated with the conventional manual exhaust valve being inadvertently left closed. The quick connect coupling enables the valve to be easily serviced or replaced.

In the same manner as a conventional bulk tank manual exhaust valve, the pressure exhaust valve of this disclosure is connected in fluid communication between the interior of a dry bulk tank and an exterior environment of the dry bulk tank. The pressure exhaust valve is also operable to vent the tank or seal the tank in substantially the same manner.

In the first position of the pressure exhaust valve, the valve communicates the interior of the bulk tank with the exterior environment of the tank and exhausts air pressure from the interior of the tank to the exterior environment. In a second position of the exhaust valve, the valve closes or seals communication between the interior of the tank and the exterior environment of the tank and enables air pressure supplied to the interior of the tank from an air pipe or other source of air pressure to build up in the interior of the tank.

The pressure exhaust valve comprises a valve, such as a butterfly valve having a valve stem. A valve housing contains the valve and the valve stem. The valve and valve stem are both rotatable about an axis of rotation in the valve housing. At one end of the valve housing opposite the butterfly valve, the valve housing has a valve housing flange. The valve housing flange is used in connecting the valve housing to an actuator of the valve. The valve housing flange has a flat engagement surface. A cylindrical tapered surface extends around the perimeter of the valve housing flange on the opposite side of the flange from the flat engagement surface of the flange. The cylindrical tapered surface around the valve housing flange has a tapered configuration relative to the axis of rotation of the valve stem and the butterfly valve. As the tapered surface extends radially inward from the periphery of the flange to the valve stem the surface tapers axially toward the butterfly valve.

The pressure exhaust valve also comprises the actuator mentioned earlier. The actuator can be the manual actuator of the blowdown exhaust valve described earlier or a pneumatic actuator that is operated by air pressure. An actuator housing of the actuator contains an actuator stem. In one embodiment a manual handle is mounted for rotation on the actuator housing and is operatively connected to the actuator stem. In another embodiment a quarter turn pneumatic actuator is contained in the actuator housing and is operatively connected to the actuator stem. Thus, the actuator stem can be rotated manually, or automatically by air pressure or by some other equivalent means. The actuator stem rotates in the actuator housing about an axis of rotation in response to rotation of the manual handle or operation of the quarter turn pneumatic actuator. The actuator stem is operatively connected to the valve stem when the valve housing and the actuator housing are connected. The axis of rotation of the actuator stem is coaxial with the axis of rotation of the valve stem. The actuator housing has an actuator housing flange that is connectable to the valve housing flange. The actuator housing flange has a flat engagement surface that engages against the flat engagement surface of the valve housing, and a cylindrical tapered surface that extends around the actuator housing flange on the opposite side of the flange from the flat surface. The cylindrical tapered surface of the actuator housing flange has a tapered configuration relative to the axis of rotation of the actuator stem. As the tapered surface extends radially inward from the periphery of the flange to the actuator stem the surface tapers axially toward the actuator.

A connector connects the valve housing flange to the actuator housing flange and thereby removably connects the valve housing to the actuator housing. The connector has a cylindrical interior surface that is attached around the valve housing flange and the actuator housing flange in connecting the valve housing and the actuator housing. A groove is formed in the cylindrical interior surface of the connector. The groove is configured for receiving the cylindrical surface of the valve housing flange and the cylindrical surface of the actuator housing flange in the groove in connecting the valve housing flange and the actuator housing flange together. The tapered configuration of the cylindrical exterior surface of the valve housing flange and the tapered configuration of the cylindrical exterior surface of the actuator housing flange extend into the groove in the clinical interior surface of the connector with the connector connecting the valve housing flange to the actuator housing flange.

A cam surface is provided on one of the valve stem and the actuator stem. A switch is mounted on one of the valve housing and the actuator housing adjacent to the cam surface. The rotation of the valve stem and the rotation of the actuator stem resulting from closing the pressure exhaust valve causes engagement of the cam surface with the switch and operation of the switch. Operation of the switch causes illumination of an indicator light on the actuator housing or at another location on the trailer that provides a visual indication of the bulk tank pressure exhaust valve being in the closed position and thereby a visual warning of the exhaust valve being in the closed position.

In the embodiment of the pressure blowdown valve or pressure exhaust valve described above that employs a quarter turn pneumatic actuator that moves the exhaust valve to the open position, there is an air sensor connected in communication with the air pipe that supplies air pressure to the interior of the bulk tank. The air sensor is an air pressure sensor that is operable to sense air pressure in the air pipe and generate an electric signal in response to sensing air pressure in the air pipe. Alternatively, the air sensor is an air flow sensor that is operable to sense a flow of air through the air pipe and generate an electric signal in response to sensing the flow of air. In a further embodiment, the solenoid of the solenoid operated valve is connected in electronic communication with a truck sensor switch that generates an electric signal when the trailer is coupled to a truck.

A solenoid operated valve is operatively communicated with the quarter turn actuator that operates the exhaust valve. The solenoid of the solenoid operated valve is connected in electronic communication with the air sensor or the truck sensor switch. The solenoid operated valve controls the operation of the pneumatic actuator. The pneumatic actuator operates the exhaust valve in response to electronic signals received by the solenoid of the solenoid operated valve. The solenoid operated valve receives the electric signals from the air sensor that senses the presence of air pressure or air flow in the air pipe, or from the switch that senses a truck being coupled to the trailer.

The solenoid operated valve is operable to control the quarter turn actuator to move the exhaust valve to the first, open position of the valve where the valve communicates the interior of the bulk tank with the exterior environment of the bulk tank. The solenoid operated valve controls the quarter turn actuator to move the exhaust valve to the first, open position in response to the air sensor sensing the absence of air pressure or the absence of an air flow in the air pipe. In addition, the solenoid operated valve is operable to control the quarter turn actuator to move the exhaust valve to the first, open position of the valve where the valve communicates the interior of the bulk tank with the exterior environment of the bulk tank in response to the trailer being disconnected from a truck. In the open position of the exhaust valve, the valve vents the interior of the bulk tank to the exterior environment of the bulk tank. The solenoid operated valve is also operable to vent air pressure from the quarter turn actuator which frees the exhaust valve and allow the exhaust valve to be manually moved to the second, close position of the valve in response to the air sensor sensing air pressure or a flow of air in the air pipe. In addition, the solenoid operated valve is operable to vent pressure from the actuator and allow the exhaust valve to be manually moved to the second, closed position of the valve in response to the switch generating an electric signal when the trailer is coupled to a truck. In the second position of the exhaust valve, the valve closes or blocks communication between the interior of the bulk tank and the exterior environment of the tank and enables the pressure supplied from the air pipe to the interior of the tank to build up in the tank. The solenoid operated valve is also operable to allow the exhaust valve to be manually throttled to partially close or block communication between the interior of the bulk tank and the exterior environment of the tank and enable an operator to control the air pressure built up in the interior of the tank. The exhaust valve and the quarter turn actuator combination hold the exhaust valve in the open position at all times except when the air sensor detects air flow in the air pipe or air pressure in the air pipe (the air sensor operates at a low enough level that just the back pressure from the air flowing through the air pipe and the solenoid valve and exhaust valve is sufficient to trigger the air sensor). When air flow is sensed in the air pipe or when the trailer is coupled to a truck, the solenoid valve vents air pressure from the quarter turn actuator and allows the operator to operate the exhaust valve as a manual valve. Then when the unloading process of the tank is complete and there is no air flow sensed by the air sensor or the trailer is disconnected from the truck, the exhaust valve will automatically be opened.

### BRIEF DESCRIPTION OF THE DRAWINGS

Further objects and features of the automated bulk tank pressure exhaust valve with quick connect and indicator light of this disclosure are set forth in the following detailed description and drawing figures.

FIG. 1 is a representation of a conventional pneumatic dry bulk trailer.

FIG. 2 is a representation of a partial view of a forward portion of the trailer represented in FIG. 1.

FIG. 3 is a representation of a partial view of the forward portion of the trailer and the pressure sensor and solenoid operated butterfly valve of the automated bulk tank pressure exhaust valve of this disclosure.

FIG. 4 is a representation of a partial view of the forward portion of the trailer and a flow sensor and solenoid operated butterfly valve of a further embodiment of the automated bulk tank pressure exhaust valve.

FIG. 5 is a representation of a perspective view of the automated bulk tank pressure exhaust valve with a quick connect and a valve closed indicator light of this disclosure.

FIG. 6 is a representation of an end elevation view of the automated bulk tank pressure exhaust valve of FIG. 5.

FIG. 7 is a representation of a rear elevation view of the automated bulk tank pressure exhaust valve.

FIG. 8 is a representation of a top plan view of the automated bulk tank pressure exhaust valve.

FIG. 9 is a representation of a cross section view of the automated bulk tank pressure exhaust valve in the plane of line 9-9 of FIG. 8.

FIG. 10 is a representation of a cross section view of the automated bulk tank pressure exhaust valve in the plane of line 10-10 of FIG. 8.

FIG. 11 is a schematic representation of the solenoid operated valve and quarter turn pneumatic actuator that operates the automated bulk tank pressure exhaust valve.

### DETAILED DESCRIPTION OF THE INVENTION

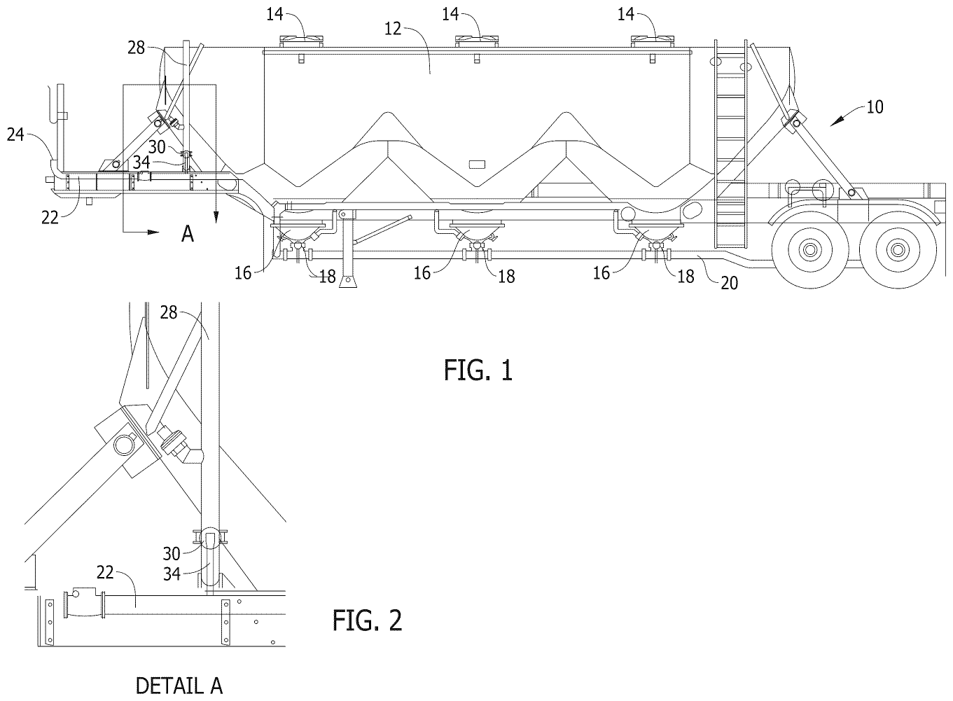

FIG. 1 and FIG. 2 are representations of the operative environment of the automated bulk tank pressure exhaust valve 36 with quick connect coupling and valve closed indicator light of this disclosure. The bulk tank pressure exhaust valve 36 of this disclosure is basically employed in place of the conventional exhaust valve 30 such as that described earlier. The bulk tank trailer 10 shown in FIG. 1 and FIG. 2 represents the construction of a conventional bulk tank trailer on which the pressure exhaust valve 36 is employed. The pressure exhaust valve 36 could be employed on various other types and various other equivalent dry bulk material trailers. The automated pressure exhaust valve 36 replaces the conventional manual blowdown valve 30 and eliminates the potential for injury associated with the conventional manual blowdown valve. The quick connect coupling enables the exhaust valve 36 to be quickly and easily removed from its connection between the tank pipe 28 and the exhaust pipe 32 for servicing of the valve or actuator or replacement. The valve closed indicator light provides a visual indication to an operator of a truck towing the dry bulk material trailer 10 or others in the vicinity of the trailer and the indicator light that the exhaust valve 36 is in the closed position allowing air pressure to build up in the tank 12 of the trailer 10.

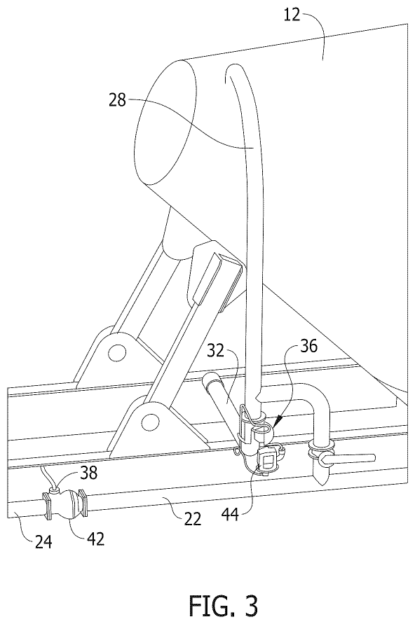

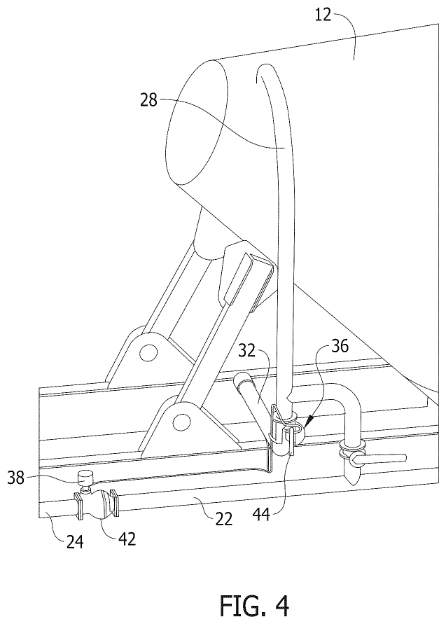

Represented in FIG. 3 and FIG. 4 is a forward portion of the pneumatic dry bulk trailer 10 of FIG. 1 and FIG. 2 on which the automated bulk tank pressure exhaust valve 36 is employed. Component parts of the dry bulk trailer 10 identified in FIG. 1 and FIG. 2 are labeled with their same reference numbers in FIG. 3 and FIG. 4.

In FIG. 3 and FIG. 4 there is represented a portion of the air pipe 22 that extends between the source of air pressure at the air pipe input end 24 to the interior of the tank 12. In FIG. 3 and FIG. 4 the air pipe 22 communicates with the interior of the tank 12 through the tank pipe 28. A pressure relief pipe or pressure exhaust pipe 32 extends from the tank pipe 28 to an exhaust opening of the exhaust pipe 32 that communicates with the exterior environment of the tank 12.

An air sensor 38 is connected in fluid communication with the air pipe 22. As represented in FIG. 3, the air sensor 38 is mounted on the housing of a check valve 42. The check valve 42 controls a supply of air traveling left to right in FIG. 3 through the air pipe 22 from the source of air pressure at the air pipe inlet end to the left in FIG. 3, to the interior of the tank 12. The check valve 42 is operable to permit a flow of air from left to right through the air pipe 22 from the source of air pressure to the left of the check valve 42 as shown in FIG. 3 to the interior of the tank 12 and prevents a reverse flow of air in the opposite direction from right to left through the check valve 42. The air sensor 38 on the check valve 42 could be an air pressure sensor such as that represented in FIG. 3 that senses a pressure of the air traveling through the air pipe 22, or an air flow sensor such as that represented in FIG. 4 that senses a flow of air through the air pipe 22.

The automated bulk tank pressure exhaust valve 36 is a quarter turn butterfly valve, although other equivalent types of valves could be employed. The exhaust valve 36 is positioned between the tank pipe 28 and the exhaust pipe 32 as represented in FIG. 3 and FIG. 4. The exhaust valve 36 is connected in fluid communication with the interior of the bulk tank 12 through the tank pipe 28. The exhaust valve 36 is also connected in fluid communication with the exterior environment of the bulk tank 12 through the exhaust pipe 32.

In a first position of the exhaust valve 36, the exhaust valve communicates the interior of the bulk tank 12 with the exterior environment of the tank through the tank pipe 28 and through the exhaust pipe 32 and air pressure from the interior of the tank 12 is exhausted to the exterior environment of the tank 12. In a second position of the exhaust valve 36, the valve closes or blocks communication between the interior of the bulk tank 12 and the exterior environment of the tank through the tank pipe 28 and the exhaust pipe 32. The exhaust valve 36 has a manual handle 44 that can be used to manually move the valve between the first and second positions when the valve is not held in the first position by the pneumatic actuator, as will be explained.

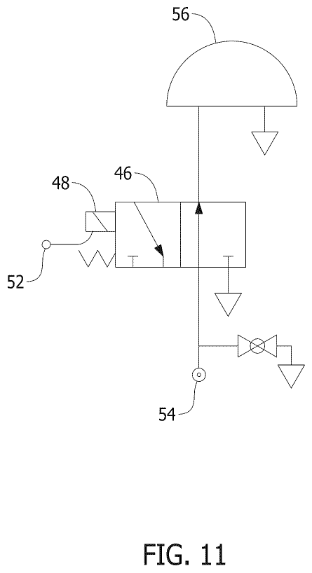

A solenoid operated valve 46 that controls the operation of the automated exhaust valve 36 is represented schematically in FIG. 11. The solenoid operated valve 46 is operated by a spring biased solenoid 48 that receives electric signals from an electric signal source 52, as will be explained. The solenoid operated valve 46 communicates pneumatically with a quarter turn actuator 56 that is operatively connected to the automated exhaust valve 36 and controls movements of the automated exhaust valve 36 between the first and second positions of the valve. Thus, the solenoid operated valve 46 controls operation of the exhaust valve 36 in response to electric signals from the electric signal source 52 that are received by the solenoid 48. The electric signal source 52 can be the air sensor 38 described earlier or can be an electric switch on a truck that produces an electric signal in response to the truck being coupled to the bulk tank trailer 10.

The air sensor 38 is operable to send electric signals to the solenoid 48 to control the solenoid to move the solenoid valve 46 which in turn controls movement of the automated exhaust valve 36 between the first and second positions of the exhaust valve. Referring to FIG. 11, the solenoid 48 and solenoid valve 46 are schematically represented. The solenoid valve 46 is shown in a first position of the solenoid valve in which a source of air pressure 54 is communicated through the solenoid valve 46 with a quarter turn actuator 56 that is operatively connected with the exhaust valve 36. The source of air pressure 54 can be a reservoir tank for the air brakes of the bulk tank trailer 10 or any other equivalent source of air pressure having sufficient volume to cycle the quarter turn actuator 56. In the first position of the solenoid valve 46 shown in FIG. 11, no signal is being sent by either of the air sensors 38 or the truck sensor 52 to the solenoid 48 and the solenoid valve 46 is spring biased to the first position shown in FIG. 11. When the solenoid 48 receives an electric signal from either of the air sensors 38 or the truck sensor 52, the solenoid 48 is controlled to move the solenoid valve 46 to the second position (the solenoid valve 46 moving to the right of the position shown in FIG. 11) where the solenoid valve 46 blocks and seals closed the source of air pressure 54 and communicates the quarter turn actuator 56 with an exhaust opening that drains fluid pressure from the actuator. The solenoid 48 is operable when no electric signal is received by the solenoid 48 to be spring biased to the first position represented in FIG. 11 in which air pressure is directed to the quarter turn actuator 56 which controls the actuator to move the exhaust valve 36 to the first position of the exhaust valve 36. In the first position the exhaust valve 36 communicates the interior of the bulk tank 12 with the exterior environment of the tank through the tank pipe 28 and the exhaust pipe 32. In the first position of the automated exhaust valve 36 the valve exhausts air pressure from the interior of the bulk tank 12 to the exterior environment.

The air sensor 38 is operable to send an electric signal to the solenoid 48 in response to the air sensor 38 sensing the presence of air pressure or the presence of a flow of air in the air pipe 22. The electric signal controls the solenoid 48 to move the solenoid valve 46 to the right of the position of the valve shown in FIG. 11 to vent the air pressure from the quarter turn actuator 56 and stop the actuator from holding the automated exhaust valve 36 in the first, open position. This allows an operator to move the manual handle 44 of the automated exhaust valve 36 to the second position of the exhaust valve where the valve is closed and blocks communication of the interior of the bulk tank 12 with the exterior environment of the tank through the tank pipe 28 and the exhaust pipe 32. In the second position of the automated exhaust valve 36 air pressure is allowed to build up in the interior of the tank 12.

The air sensor 38 and the solenoid valve 46 work together to ensure that when no air pressure is being delivered to the interior of the tank 12, the solenoid valve 46 moves the quarter turn actuator 56 and thereby the automated exhaust valve 36 to the first position which vents the interior of the tank 12 through the tank pipe 28 and the exhaust pipe 32 preventing any unintended buildup of air pressure in the interior of the tank 12.

The truck switch 52 functions as the electric signal source to produce an electric signal when a truck is coupled to the bulk tank trailer 10 and operates in substantially the same manner as the air sensor 38. The truck switch 52 is operable to send an electric signal to the solenoid 48 in response to the truck switch sensing the coupling of a truck to the trailer 10 and the resulting connection of a blower on the truck to the trailer. The electric signal controls the solenoid 48 to move the solenoid valve 46 to the right of the position shown in FIG. 11 draining air pressure from the quarter turn actuator 56. This allows an operator to move the manual handle 44 of the automated exhaust valve 36 to the second position of the exhaust valve where the valve is closed and blocks communication of the interior of the bulk tank 12 with the exterior environment of the tank through the tank pipe 28 and the exhaust pipe 32. In the second position of the automated exhaust valve 36 air pressure is allowed to build up in the interior of the tank 12.

The truck sensor 52 and the solenoid valve 46 work together to ensure that when the truck is disconnected from the trailer and no air pressure is being delivered to the interior of the tank 12, the solenoid valve 46 moves the quarter turn actuator 56 and thereby the automated exhaust valve 36 to the first position which vents the interior of the tank 12 through the tank pipe 28 and the exhaust pipe 32 preventing any unintended buildup of air pressure in the interior of the tank 12.

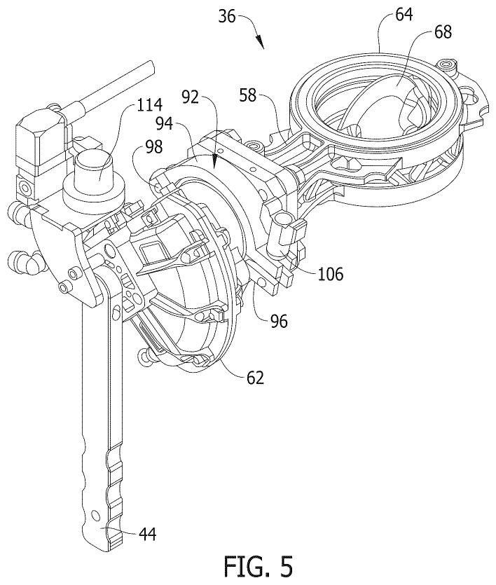

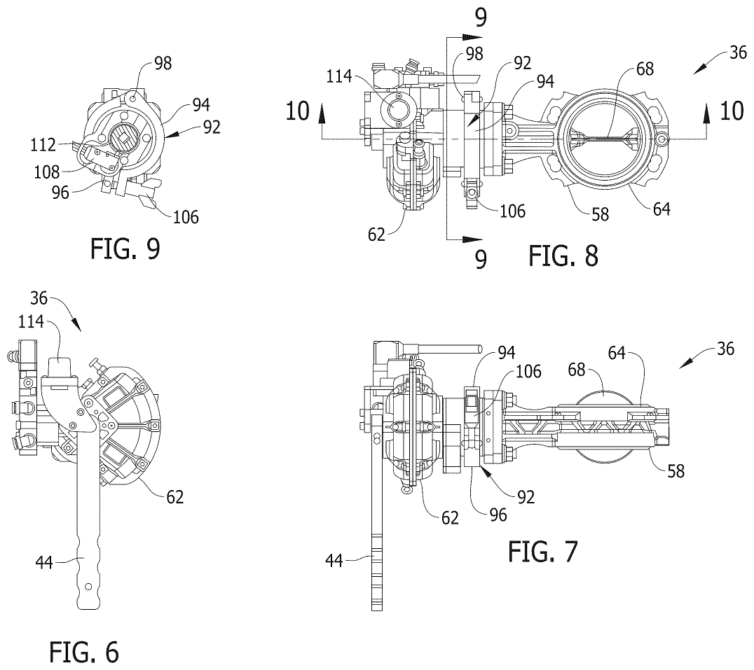

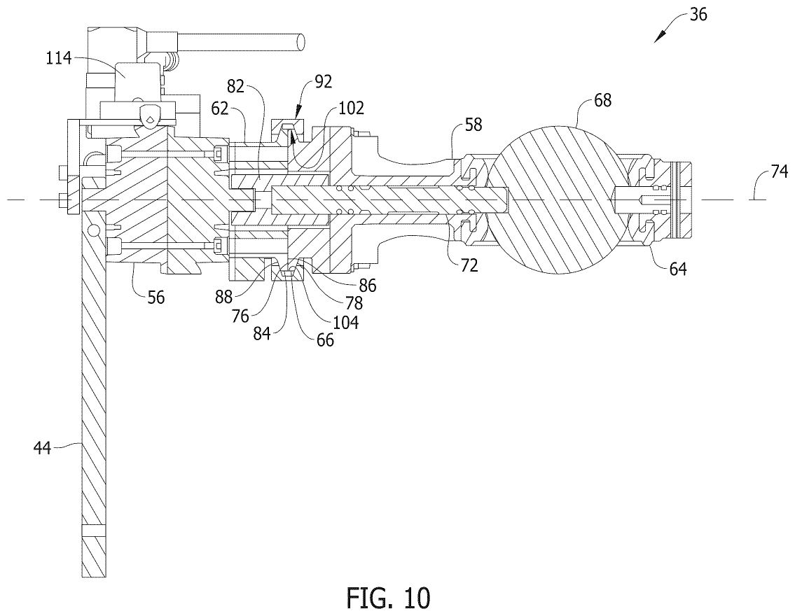

The automated bulk tank pressure exhaust valve 36 having a quick connect coupling and valve closed indicator light is shown removed from between the tank pipe 28 and the exhaust pipe 32 in FIG. 5. A cross section of the construction of the automated exhaust valve 36 is represented in FIG. 10. The automated bulk tank pressure exhaust valve 36 basically comprises a valve housing 58 and an actuator housing 62.

The valve housing 58 has a cylindrical valve collar 64 at one end and a valve housing flange 66 at the opposite end. The valve collar 64 is configured for attachment to the tank pipe 28 at the top of the valve collar as represented in FIGS. 2-4 and is configured for attachment to the exhaust pipe 32 at the bottom of the valve collar as represented in FIGS. 2-4. The cylindrical interior of the valve collar 64 contains a valve, for example a butterfly valve 68. The butterfly valve 68 has a valve stem 72 that is mounted in the valve housing 58 for rotation of the valve stem about an axis of rotation 74 represented in FIG. 10.

The valve housing flange 66 has a flat engagement surface 76 that is configured for engagement with an engagement surface of the actuator housing 62, as will be explained. A cylindrical tapered surface 78 extends around the perimeter of the valve housing flange 66 on the opposite side of the flange from the flat engagement surface 76. The cylindrical tapered surface 78 around the valve housing flange 66 has a tapered configuration relative to the axis of rotation 74 of the valve stem 72 and the butterfly valve 68. As the tapered surface 78 extends radially inward from the periphery of the flange 66 to the valve stem 72 the surface tapers axially toward the butterfly valve 68.

The automated pressure exhaust valve 36 also comprises the actuator 56 mentioned earlier. The actuator 56 can be the manual actuator of the blowdown exhaust valve described earlier, or the pneumatic actuator 56 that is operated by air pressure. The actuator housing 62 of the actuator comprises an actuator stem 82. In one embodiment the manual handle 34 is mounted for rotation on the actuator housing 62 and is operatively connected to the actuator stem 82. In another embodiment the quarter turn pneumatic actuator 56 is contained in the actuator housing 62 and is operatively connected to the actuator stem 82. Thus, the actuator stem 82 can be rotated manually, or automatically by air pressure or by some other equivalent means. The actuator stem 82 rotates in the actuator housing 62 about an axis of rotation 74 in response to rotation of the manual handle 34 or operation of the quarter turn pneumatic actuator 56. The actuator axis of rotation 74 is coaxial width and is the same axis of rotation 74 of the valve stem 72. The actuator stem 82 is operatively connected to the valve stem 72 when the valve housing 58 and the actuator housing 62 are connected.

The actuator housing 62 has the quarter turn actuator 56 at one end and an actuator housing flange 84 at the opposite end. The actuator housing flange 84 is connectable to the valve housing flange 66. The actuator housing flange 84 has a flat engagement surface 86 that engages against the flat engagement surface 76 of the valve housing 58, and a cylindrical tapered surface 88 that extends around the actuator housing flange 84 on the opposite side of the flange from the flat engagement surface 86. The cylindrical tapered surface 88 of the actuator housing flange 84 has a tapered configuration relative to axis of rotation 74 of the actuator stem 82. As the tapered surface 88 extends radially inward from the periphery of the flange 84 to the actuator stem 82 the surface tapers axially toward the quarter turn actuator 56.

A connector 92 is removably attachable to the valve housing flange 66 and the actuator housing flange 84 to releasably connect the valve housing 58 and the actuator housing 62 together. The connector 92 is comprised of a first crescent shaped section 94 and a second crescent shaped section 96 that are connected by a pivot connection 98. The first crescent shaped section 94 has an interior surface 102 with a V shaped groove therein and the second crescent shaped section 96 has an interior surface 104 with a V shaped groove therein. Together the grooves in the interior surface 102 of the first crescent shaped section 94 and the interior surface 104 of the second crescent shaped section 96 receive the valve housing cylindrical tapered surface 78 and the actuator housing cylindrical tapered surface 88 when attaching the connector 92 around the valve housing flange 66 and the actuator housing flange 84. A manually adjustable fastener 106 is connected between the first crescent shaped section 94 and the second crescent shaped section 96 opposite the pivot connection 98. Manually turning an internally screw threaded nut of the fastener 106 on an externally screw threaded bolt of the fastener 106 tightens the first crescent shaped section 94 and the second crescent shaped section 96 around the tapered cylindrical surfaces 78, 88 of the valve housing flange 66 and the actuator housing flange 84 and removably connects the housings together. The connector 92 thereby provides a quick connect coupling between the valve housing 58 and the actuator housing 62.

Referring to FIG. 9, a switch, for example a micro switch 108 is mounted in the interior of the actuator housing 62. The switch 108 is positioned in the actuator housing 62 where an operator of the switch will be engaged by a cam surface 112 on the actuator stem 82 when the actuator stem 82, the valve stem 72 and the butterfly valve 68 are rotated to the closed positions. Alternatively, the cam surface could be provided on the valve stem in which case the switch 108 would be located in the valve housing 58. The switch 108 is operatively communicated with an indicator light 114 mounted on the exterior of the actuator housing 62. Engagement of the cam surface 112 with the operator of the switch 108 causes the switch to close which in turn causes illumination of the indicator light 114. Illumination of the indicator light 114 provides a visual indication to the operator of the truck towing the trailer 10 and to others in the vicinity of the trailer 10 viewing the indicator light 114 that the bulk tank pressure exhaust valve 36 is in the closed position and air pressure is built up in the tank 12 of the trailer 10.

When a truck for towing the trailer 10 is connected to the trailer, electric power from the truck, for example from a generator of the truck is supplied to the solenoid 48 of the solenoid valve 46 that controls the valve to vent air pressure from the actuator. The electric power supplied to the solenoid 48 of the solenoid valve 46 moves the solenoid valve 46 to the right of the position shown in FIG. 11 and vents air pressure from the quarter turn actuator 56. With the quarter turn actuator 56 vented, there is no air pressure holding the bulk tank pressure exhaust valve 36 in the open position and the valve 36 can be opened and closed manually by manipulation of the handle 44 that is operatively connected to the valve stem 72. If the valve 36 is manually closed, the cam surface 112 operates the switch 108 and the valve closed indicator light 114 is illuminated. If the valve 36 is manually opened, the cam surface 112 disengages from the switch 108 and the indicator light 114 is turned off. When electric power from the truck is turned off or disconnected, the solenoid operated valve 46 is moved to the position represented in FIG. 11 and air pressure from the source of air pressure 54 on the trailer 10 is supplied to the quarter turn actuator 56 and the actuator moves the bulk tank pressure exhaust valve 36 to the open position and holds the valve in the open position. In this situation, the bulk tank pressure exhaust valve 36 cannot be moved manually and it is held in the open position as a safety feature. The valve 36 cannot be moved manually until power is again supplied to the trailer 10 and the solenoid 48 of the solenoid operated valve 46.

as various modifications could be made in the construction of the automated bulk tank pressure exhaust valve and its method of operation herein described and illustrated without departing from the scope of the invention, it is intended that all matter contained in the foregoing description or shown in the accompanying drawings shall be interpreted as illustrative only rather than limiting. Thus, the breadth and scope of the present disclosure should not be limited by any of the above described exemplary embodiments, that should be defined only in accordance with the following claims appended hereto and their equivalents.

1. A bulk tank trailer pressure exhaust comprising:
an exhaust valve, the exhaust valve being connected in communication with an interior volume of a tank of a bulk tank trailer, the exhaust valve being operable to move between opened and closed configurations of the exhaust valve where in the opened configuration the exhaust valve opens communication between the interior volume of the tank and an exterior environment of the tank through the exhaust valve and in the closed configuration the exhaust valve closes communication between the interior volume of the tank and the exterior environment of the tank through the exhaust valve;
a sensor on the bulk tank trailer, the sensor being operable to sense an exterior environment condition and produce a signal in response to the sensor sensing the exterior environment condition; and
an actuator communicating with the sensor and being operatively connected to the exhaust valve, the actuator being operable to move the exhaust valve to the opened configuration of the exhaust valve in response to the sensor not producing a signal and the actuator being operable to enable the exhaust valve to move between the opened configuration and the closed configuration of the exhaust valve in response to the sensor producing the signal.

2. The bulk tank trailer pressure exhaust of claim 1, further comprising:
the sensor being operable to sense an air flow to the interior volume of the tank of the bulk tank trailer.

3. The bulk tank trailer pressure exhaust of claim 1, further comprising:
the sensor being operable to sense an air pressure in the interior volume of the tank of the bulk tank trailer.

4. The bulk tank trailer pressure exhaust of claim 1, further comprising:
the sensor being operable to sense a truck coupled to the bulk tank trailer.

5. The bulk tank trailer pressure exhaust of claim 1, further comprising:
an alert on the bulk tank trailer, the alert communicating with the sensor and being operable to produce an alert in response to the sensor sensing the exterior environment condition.

6. The bulk tank trailer exhaust of claim 5, for the comprising:
the alert being a visible alert.

7. The bulk tank trailer exhaust of claim 5, further comprising:
the alert being an audible alert.

8. The bulk tank trailer exhaust of claim 1, further comprising:
a valve housing containing the exhaust valve;
an actuator housing containing the actuator; and
a connector extending around the valve housing and extending around the actuator housing and releasably connecting the valve housing to the actuator housing.

9. The bulk tank trailer exhaust of claim 8, further comprising:
the valve housing having a flat surface;
the actuator housing having a flat surface; and
the flat surface of the valve housing engaging against the flat surface of the actuator housing with the connector extending around the valve housing and extending around the actuator housing and releasably connecting the valve housing to the actuator housing.

10. The bulk tank trailer exhaust of claim 8, further comprising:
the valve housing having a tapered surface extending around the valve housing;
the actuator housing having a tapered surface extending around the actuator housing; and
the connector extending around the tapered surface extending around the valve housing and around the tapered surface extending around the actuator housing and releasably connecting the valve housing to the actuator housing.

11. A bulk tank trailer pressure exhaust comprising:
an exhaust valve, the exhaust valve being connected in communication between an interior volume of a tank of a bulk tank trailer and an exterior environment of the tank;
a switch, the switch being operable to produce a signal and being operable to interrupt the signal;
a solenoid valve connected in communication with the switch and operatively connected with a source of fluid pressure, the solenoid valve being operable to open communication of fluid pressure from the source of fluid pressure through the solenoid valve in response to the solenoid valve receiving a signal from the switch and the solenoid valve being operable to close communication of fluid pressure from the source of fluid pressure through the solenoid valve in response to the switch interrupting the signal; and
an actuator in fluid communication with the solenoid valve, the actuator being operatively connected to the exhaust valve, the actuator being operable to move the exhaust valve to communicate the interior volume of the tank with the exterior environment in response to the solenoid valve opening communication of fluid pressure through the solenoid valve and the actuator being operable to enable the exhaust valve to open and close communication between the interior volume of the tank and the exterior environment in response to the solenoid valve closing communication of the fluid pressure through the solenoid valve.

12. The bulk tank trailer pressure exhaust of claim 11, further comprising:
the switch being operable to produce the signal in response to an air flow to the interior volume of the tank of the bulk tank trailer.

13. The bulk tank trailer pressure exhaust of claim 11, further comprising:
the switch being operable to produce the signal in response to an air pressure in the interior volume of the tank of the bulk tank trailer.

14. The bulk tank trailer pressure exhaust of claim 11, further comprising:
the switch being operable to produce the signal in response to a truck being coupled to the bulk tank trailer.

15. The bulk tank trailer pressure exhaust of claim 11, further comprising:
an alert on the bulk tank trailer, the alert communicating with the switch and being operable to produce an alert in response to the switch producing the signal.

16. The bulk tank trailer exhaust of claim 15, for the comprising:
the alert being a visible alert.

17. The bulk tank trailer exhaust of claim 15, further comprising:
the alert being an audible alert.

18. The bulk tank trailer exhaust of claim 11, further comprising:
a valve housing containing the exhaust valve;
an actuator housing containing the actuator; and
a connector extending around the valve housing and extending around the actuator housing and releasably connecting the valve housing to the actuator housing.

19. The bulk tank trailer exhaust of claim 18, further comprising:
the valve housing having a flat surface;
the actuator housing having a flat surface; and
the flat surface of the valve housing engaging against the flat surface of the actuator housing with the connector extending around the valve housing and extending around the actuator housing and releasably connecting the valve housing to the actuator housing.

20. The bulk tank trailer exhaust of claim 18, further comprising:
the valve housing having a tapered surface extending around the valve housing;
the actuator housing having a tapered surface extending around the actuator housing; and
the connector extending around the tapered surface extending around the valve housing and around the tapered surface extending around the actuator housing and releasably connecting the valve housing to the actuator housing.
